(19) United States
(12) Patent Application Publication
(10) Pub. No.: US 2018/0101064 A1
(43) Pub. Date: Apr. 12, 2018

(54) BACKLIGHT MODULES AND DOUBLE-SIDED DISPLAY DEVICES

(71) Applicant: Shenzhen China Star Optoelectronics Technology Co., Ltd., Shenzhen, Guangdong (CN)

(72) Inventors: Yong FAN, Shenzhen, Guangdong (CN); Yuchun HSIAO, Shenzhen, Guangdong (CN)

(73) Assignee: Shenzhen China Star Optoelectronics Technology Co., Ltd., Shenzhen, Guangdong (CN)

(21) Appl. No.: 15/107,188

(22) PCT Filed: May 26, 2016
(86) PCT No.: PCT/CN2016/083555

§ 371 Date: Jun. 22, 2016

(30) Foreign Application Priority Data
Apr. 29, 2016 (CN) 201610280397.3

(51) Int. Cl. G02F 1/1335

(52) U.S. Cl. CPC G02F 1/133603; G02F 2001/133342; G02F 1/133608; G02F 1/133606

(57) ABSTRACT

The backlight module includes a plastic frame, a first light guiding plate received within the plastic frame, a second light guiding plate, a quantum dot (QD) fluorescent film and a backlit lamp. The first light guiding plate includes a first bottom surface, and a first light incident surface connecting with the first bottom surface. The second light guiding plate includes a second bottom surface and a second light incident surface connecting with the second bottom surface. The first bottom surface is opposite to the second bottom surface. The QD fluorescent film is arranged between the first bottom surface the second bottom surface. The backlit lamp is arranged on one side of the first light incident surface and the second light incident surface, and light emitting surfaces of the first light guiding plate and the second light guiding plate are respectively configured with an optical film layer.

### CROSS REFERENCE

This application claims the priority of Chinese Patent Application No. 201610280397.3, entitled “Backlight modules and double-sided display devices”, filed on Apr. 29, 2016, the disclosure of which is incorporated herein by reference in its entirety.

### FIELD OF THE INVENTION

The present invention relates to a liquid crystal display technology field, and more particularly to a backlight module and a double-sided display device.

### BACKGROUND OF THE INVENTION

With the development of the optical-electronics and the semiconductor technology, the flat panel displays have been increasingly developed. Among the flat panel displays, liquid crystal displays (LCDs) have been adopted in variety of aspects due to the attributes, such as high space efficiency, low power consumption, and low electromagnetics. Generally, backlit is configured to operate as the light source of liquid crystal panels. Conventionally, the backlight module includes a backlight source having LEDs. The light beams from the backlight source are converted to be the surface light source by the light guiding plate. The light beams passing through the diffuser are then emitted out from the backlight module to display the images after passing through the liquid crystal panel. Currently, double-sided display has been adopted by commercial applications. However, compared to two independent liquid crystal panels, only one back plate is excluded from the double-sided display, and thus the cost is still high.

### SUMMARY OF THE INVENTION

The present disclosure relates to a backlight module and a double-sided display device to reduce the cost while the brightness of the double-sided display panels are the same.

In one aspect, a backlight module includes: a plastic frame, a first light guiding plate received within the plastic frame, a second light guiding plate, a quantum dot (QD) fluorescent film and a backlit lamp, the first light guiding plate comprises a first bottom surface, and a first light incident surface connecting with the first bottom surface, the second light guiding plate comprises a second bottom surface and a second light incident surface connecting with the second bottom surface, the first bottom surface is opposite to the second bottom surface, the QD fluorescent film is arranged between the first bottom surface the second bottom surface, the backlit lamp is arranged on one side of the first light incident surface and the second light incident surface, and light emitting surfaces of the first light guiding plate and the second light guiding plate are respectively configured with an optical film layer.

Wherein dots are configured on the first bottom surface and the second bottom surface.

Wherein the light emitting surfaces of the first light guiding plate and the second light guiding plate are both the light emitting surface, the optical film layer is a diffusing film, and the diffusing film adheres to the light emitting surface of the first light guiding plate and the second light guiding plate.

Wherein the light emitting surfaces of the first light guiding plate and the second light guiding plate are both the light emitting surface, and the light emitting surfaces of the first light guiding plate and the second light guiding plate are configured with dots.

Wherein the backlit lamp comprises a circuit board and a blue light LED lamp arranged on the circuit board.

Wherein the first light guiding plate is made by glass material, and the second light guiding plate is made by optical-scale acrylic.

In another aspect, a backlight module includes: a plastic frame, a light guiding plate received within the plastic frame, a QD fluorescent film, two optical film layers and a backlit lamp, the light guiding plate comprises a first light emitting surface, a second light emitting surface, and a light incident surface connecting the first light emitting surface and the second light emitting surface, the optical film layer respectively adheres to the first light emitting surface and the second light emitting surface, the backlit lamp is arranged on one side of the light incident surface, and the QD fluorescent film is arranged between the backlit lamp and the light incident surface.

Wherein the optical film layers comprises a diffusing film and an optical film stacked on the first light emitting surface and the second light emitting surface of the light guiding plate.

Wherein the first light emitting surface and the second light emitting surface are configured with dots.

In another aspect, a double-sided display device includes: two liquid crystal panel and a backlight module, a plastic frame, a first light guiding plate received within the plastic frame, a second light guiding plate, a quantum dot (QD) fluorescent film and a backlit lamp, the first light guiding plate comprises a first bottom surface, and a first light incident surface connecting with the first bottom surface, the second light guiding plate comprises a second bottom surface and a second light incident surface connecting with the second bottom surface, the first bottom surface is opposite to the second bottom surface, the QD fluorescent film is arranged between the first bottom surface and the second bottom surface, the backlit lamp is arranged on one side of the first light incident surface and the second light incident surface, and light emitting surfaces of the first light guiding plate and the second light guiding plate are respectively configured with an optical film layer, and the two liquid crystal panels are arranged above the two optical film layers.

Wherein dots are configured on the first bottom surface and the second bottom surface.

Wherein the light emitting surfaces of the first light guiding plate and the second light guiding plate are both the light emitting surface, the optical film layer is a diffusing film, and the diffusing film adheres to the light emitting surface of the first light guiding plate and the second light guiding plate.

Wherein the light emitting surfaces of the first light guiding plate and the second light guiding plate are both the light emitting surface, and the light emitting surfaces of the first light guiding plate and the second light guiding plate are configured with dots.

Wherein the backlit lamp comprises a circuit board and a blue light LED lamp arranged on the circuit board.

Wherein the first light guiding plate is made by glass material, and the second light guiding plate is made by optical-scale acrylic.

In another aspect, a double-sided display device includes: two liquid crystal panels and a backlight module, the backlight module comprises a plastic frame, a light guiding plate received within the plastic frame, a QD fluorescent film, two optical film layers and a backlit lamp, the light guiding plate comprises a first light emitting surface, a second light emitting surface, and a light incident surface connecting the first light emitting surface and the second light emitting surface, the optical film layer respectively adheres to the first light emitting surface and the second light emitting surface, the backlit lamp is arranged on one side of the light incident surface, and the QD fluorescent film is arranged between the backlit lamp and the light incident surface, and the two liquid crystal panels are arranged above the two optical film layers.

Wherein the optical film layers comprises a diffusing film and an optical film stacked on the first light emitting surface and the second light emitting surface of the light guiding plate.

Wherein the first light emitting surface and the second light emitting surface are configured with dots.

In view of the above, the QD fluorescent film is arranged between two light guiding plates. The light beams enter the light guiding plate and enter the QD fluorescent film via the surface provided with the dots to activate the QDs to form the red light beams and the green light beams, which are then mixed with the blue light beams from the LED to form the white light beams. Afterward, the white light beams pass through the first light guiding plate 10 and the second light guiding plate 15 and are emitted out from the light emitting surfaces so as to enter the two liquid crystal panels. The color gamut performance is enhanced, and only one light guiding plate is included, which saves the material. In addition, the displayed color of the two liquid crystal panels is uniform.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a cross sectional view of the backlight module in accordance with one embodiment.

FIG. 2 is a cross sectional view of the double-sided display device of FIG. 1.

FIG. 3 is a cross sectional view of the backlight module in accordance with another embodiment.

FIG. 4 is a cross sectional view of the double-sided display device of FIG. 3.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

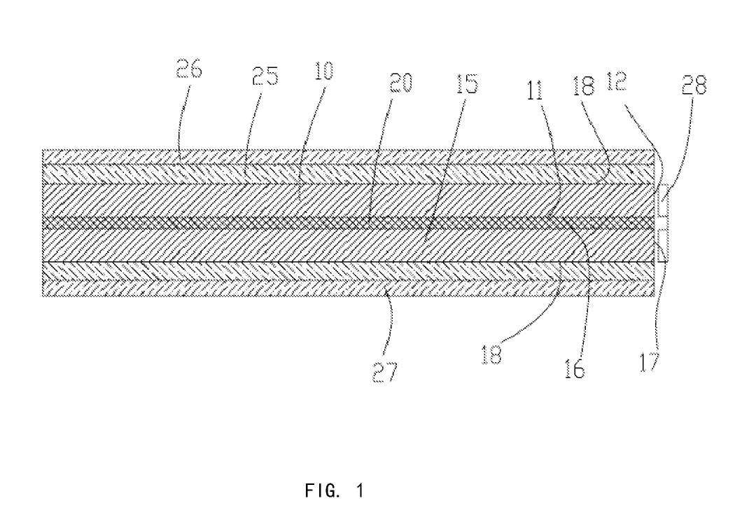

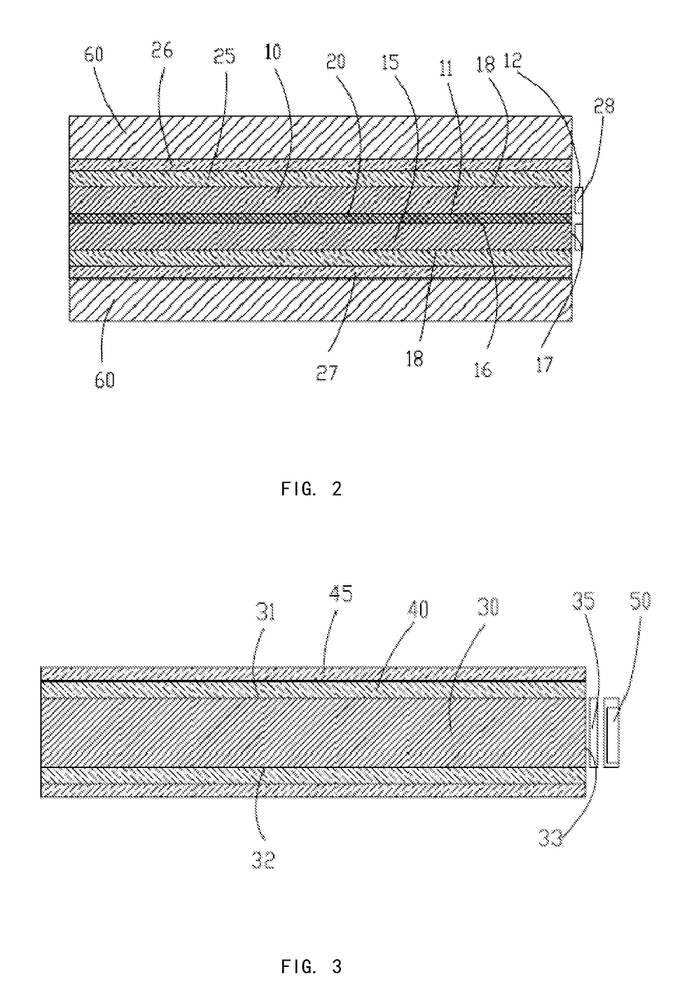

Referring to FIGS. 1 and 2, the present disclosure relates to a backlight module and a double-sided display device. The backlight module provides a light source for the double-sided display device. The backlight module includes a plastic frame (not shown), a first light guiding plate 10 received within the plastic frame, a second light guiding plate 15, a quantum dot (QD) fluorescent film 20, two optical film layers and a backlit lamp 28. The first light guiding plate 10 includes a first bottom surface 11, and a first light incident surface 12 connecting with the first bottom surface 11. The second light guiding plate 15 includes a second bottom surface 16 and a second light incident surface 17 connecting with the second bottom surface 16. The first bottom surface 11 is opposite to the second bottom surface 16. The QD fluorescent film 20 is arranged between the first bottom surface 11 and the second bottom surface 16. The backlit lamp 28 is arranged on one side of the first light incident surface 12 and the second light incident surface 17. The two optical film layers are respectively adheres to light emitting surfaces of the first light guiding plate 10 and the second light guiding plate 15. In the embodiment, the optical film layer includes an optical film 25 and a diffusing film. The optical film 25 may be an antireflection film or a light filter film.

In the embodiment, dots are configured on the first bottom surface 11 and the second bottom surface 16 for changing a direction of the light beams entering the light guiding plate. The light emitting surfaces of the first light guiding plate 10 and the second light guiding plate 15 are both the light emitting surface 18. In other embodiments, the dots are configured on the light emitting surface of the first light guiding plate 10 and the second light guiding plate 15. The two optical films 25 are respectively adheres to the light emitting surface 18 of the first light guiding plate 10 and the second light guiding plate 15, and the a diffusing film 26 is arranged between the two optical films 25. A diffusing film 27 is arranged between the light emitting surface 18 of the second light guiding plate 15 and the corresponding optical film 25. The light beams passes through the diffusing film made by PET such that the light beams are converted into an uniform surface light source to obtain the optical diffusion effect. In the embodiment, the plastic frame includes a side plate defines a receiving space to receive the first light guiding plate 10, the second light guiding plate 15, the QD fluorescent film 20, and the backlit lamp 28. The first light guiding plate 10, the QD fluorescent film 20, the second light guiding plate 15, and the optical film layers are stacked.

The first light guiding plate 10 and the second light guiding plate 15 are made by optical-scale acrylic or PC sheets. When the dimension of the backlight module is large, one of the first light guiding plate 10 and the second light guiding plate 15 is made by glass material, and the other one is made by PMMA. For instance, the first light guiding plate 10 is made by the glass material, and the second light guiding plate 15 is made by PMMA. The hardness of the glass material is strong, and thus the hardness of the backlight module is increased such that the hardness of the backlight module is increased. The backlit lamp 28 includes a circuit board and a blue-light LED arranged on the circuit board.

Referring to FIG. 2, the double-sided display device includes two liquid crystal panels 60. The liquid crystal panels 60 are arranged above the two optical films 25. The light beams from the backlit lamp 28 pass through the first light guiding plate 10 and the second light guiding plate 15, and respectively enter the two liquid crystal panels 60. In the embodiment, the QD fluorescent film 20 is arranged between two light guiding plates. The light beams enter the light guiding plate and enter the QD fluorescent film 20 via the surface provided with the dots to activate the QDs to form the red light beams and the green light beams, which are then mixed with the blue light beams from the LED to form the white light beams. Afterward, the white light beams pass through the first light guiding plate 10 and the second light guiding plate 15 and are emitted out from the light emitting surfaces so as to enter the two liquid crystal panels. The color gamut performance is enhanced, and only one QD fluorescent film 20 is included, which saves the material. In addition, the brightness and the chromaticity of the light beams emitted from the two light guiding plates are the same such that the displayed color of the two liquid crystal panels 60 is uniform.

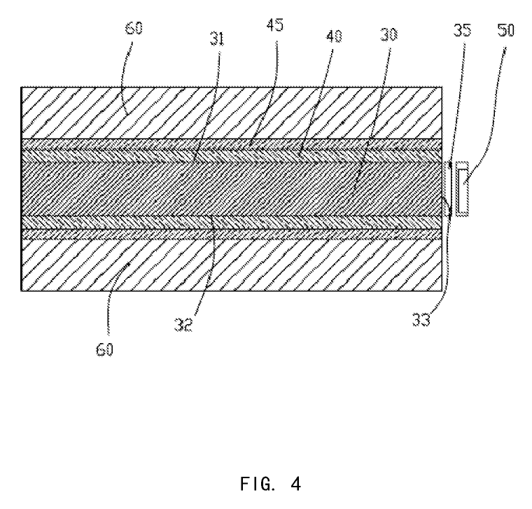

Referring to FIGS. 3 and 4, the backlight module includes a plastic frame (not shown), a light guiding plate 30 received within the plastic frame, a QD fluorescent film 35, two optical film layers and a backlit lamp 50. The light guiding plate 30 includes a first light emitting surface 31, a second light emitting surface 32, and a light incident surface 33 connecting the first light emitting surface 31 and the second light emitting surface 32. Each of the optical film layers includes a diffusing film 40 and an optical film 45. The diffusing film 40 respectively adheres to the first light emitting surface 31 and the second light emitting surface 32. The two optical films 45 respectively adhere to the two diffusing films 40. The backlit lamp 50 is arranged on one side of the light incident surface 33. The QD fluorescent film 35 is arranged between the backlit lamp 50 and the light incident surface 33. In the embodiment, the light guiding plate 30 is configured with the light incident surface 33. In other embodiment, the light guiding plate 30 includes two light incident surfaces 33. Correspondingly, two backlit lamps 50 are provided, which are respectively configured on one side of the two light incident surfaces. Referring to FIG. 4, the backlight module and the two liquid crystal panels 60 constitute the double-sided display device. The optical film 45 may be an antireflection film or a light filter film.

Further, the dots are configured on the first light emitting surface 31 or the second light emitting surface 32. In one embodiment, the dots are configured on the first light emitting surface 31. The light beams from the backlit lamp 50 activate the QD fluorescent film 20 to form red light beams and green light beams. Afterward, the red light beams and the green light beams are mixed with the blue light beams of the LED to form the white light beams, which enter the light guiding plate 30 and then are emitted out via the light emitting surface. The color gamut performance is enhanced, and only one light guiding plate is included, which saves the material. In addition, the displayed color of the two liquid crystal panels is uniform. In addition, the diffusing film 40 may prevent the difference between the backlit brightness of two sides of the light guiding plate 30 from being too huge. Also, the interference fringe issue between the dots of the light guiding plate 30 and the pixel array of the liquid crystal panel is avoided.

Above are embodiments of the present invention, which does not limit the scope of the present invention. Any modifications, equivalent replacements or improvements within the spirit and principles of the embodiment described above should be covered by the protected scope of the invention.

1. A backlight module, comprising:
a plastic frame, a first light guiding plate received within the plastic frame, a second light guiding plate, a quantum dot (QD) fluorescent film and a backlit lamp, the first light guiding plate comprises a first bottom surface, and a first light incident surface connecting with the first bottom surface, the second light guiding plate comprises a second bottom surface and a second light incident surface connecting with the second bottom surface, the first bottom surface is opposite to the second bottom surface, the QD fluorescent film is arranged between the first bottom surface the second bottom surface, the backlit lamp is arranged on one side of the first light incident surface and the second light incident surface, and light emitting surfaces of the first light guiding plate and the second light guiding plate are respectively configured with an optical film layer.

2. The backlight module as claimed in claim 1, wherein dots are configured on the first bottom surface and the second bottom surface.

3. The backlight module as claimed in claim 1, wherein the light emitting surfaces of the first light guiding plate and the second light guiding plate are both the light emitting surface, the optical film layer is a diffusing film, and the diffusing film adheres to the light emitting surface of the first light guiding plate and the second light guiding plate.

4. The backlight module as claimed in claim 1, wherein the light emitting surfaces of the first light guiding plate and the second light guiding plate are both the light emitting surface, and the light emitting surfaces of the first light guiding plate and the second light guiding plate are configured with dots.

5. The backlight module as claimed in claim 1, wherein the backlit lamp comprises a circuit board and a blue light LED lamp arranged on the circuit board.

6. The backlight module as claimed in claim 1, wherein the first light guiding plate is made by glass material, and the second light guiding plate is made by optical-scale acrylic.

7. A backlight module, comprising:
a plastic frame, a light guiding plate received within the plastic frame, a QD fluorescent film, two optical film layers and a backlit lamp, the light guiding plate comprises a first light emitting surface, a second light emitting surface, and a light incident surface connecting the first light emitting surface and the second light emitting surface, the optical film layer respectively adheres to the first light emitting surface and the second light emitting surface, the backlit lamp is arranged on one side of the light incident surface, and the QD fluorescent film is arranged between the backlit lamp and the light incident surface.

8. The backlight module as claimed in claim 7, wherein the optical film layers comprises a diffusing film and an optical film stacked on the first light emitting surface and the second light emitting surface of the light guiding plate.

9. The backlight module as claimed in claim 7, wherein the first light emitting surface and the second light emitting surface are configured with dots.

10. A double-sided display device, comprising:
two liquid crystal panel and a backlight module, a plastic frame, a first light guiding plate received within the plastic frame, a second light guiding plate, a quantum dot (QD) fluorescent film and a backlit lamp, the first light guiding plate comprises a first bottom surface, and a first light incident surface connecting with the first bottom surface, the second light guiding plate comprises a second bottom surface and a second light incident surface connecting with the second bottom surface, the first bottom surface is opposite to the second bottom surface, the QD fluorescent film is arranged between the first bottom surface and the second bottom surface, the backlit lamp is arranged on one side of the first light incident surface and the second light incident surface, and light emitting surfaces of the first light guiding plate and the second light guiding plate are respectively configured with an optical film layer, and the two liquid crystal panels are arranged above the two optical film layers.

11. The double-sided display device as claimed in claim 10, wherein dots are configured on the first bottom surface and the second bottom surface.

12. The double-sided display device as claimed in claim 10, wherein the light emitting surfaces of the first light guiding plate and the second light guiding plate are both the light emitting surface, the optical film layer is a diffusing film, and the diffusing film adheres to the light emitting surface of the first light guiding plate and the second light guiding plate.

13. The double-sided display device as claimed in claim 10, wherein the light emitting surfaces of the first light guiding plate and the second light guiding plate are both the light emitting surface, and the light emitting surfaces of the first light guiding plate and the second light guiding plate are configured with dots.

14. The double-sided display device as claimed in claim 10, wherein the backlit lamp comprises a circuit board and a blue light LED lamp arranged on the circuit board.

15. The double-sided display device as claimed in claim 10, wherein the first light guiding plate is made by glass material, and the second light guiding plate is made by optical-scale acrylic.

16-18. (canceled)
